(19) United States
(12) Patent Application Publication
(10) Pub. No.: US 2013/0006561 A1
(43) Pub. Date: Jan. 3, 2013

(54) COMPUTING DEVICE, STORAGE MEDIUM, AND METHOD FOR ANALYZING SIGNAL GROUP DELAY OF PRINTED CIRCUIT BOARD

(75) Inventors: PO-CHUAN HSIEH, Tu-Cheng (TW); CHUN-JEN CHEN, Tu-Cheng (TW); YING-TSO LAI, Tu-Cheng (TW); EN-SHUO CHANG, Tu-Cheng (TW)

(73) Assignee: HON HAI PRECISION INDUSTRY CO., LTD., Tu-Cheng (TW)

(21) Appl. No.: 13/451,433

(22) Filed: Apr. 19, 2012

(30) Foreign Application Priority Data
Jun. 28, 2011 (TW) 100122554

(51) Int. Cl. G06F 19/00

(52) U.S. Cl. 702/79

(57) ABSTRACT

In a method for analyzing a signal group delay of a printed circuit board (PCB) using a computing device, the computing device connects to a signal measuring device that measures S-parameters from a pair of data signal line and clock signal line of the PCB. The method analyzes a differential loss coefficient of the data signal line and the clock signal line based on the S-parameters, and calculates a first signal delay of the data signal line and a second signal delay of the clock signal line according to the differential loss coefficient. The method further analyzes a signal group delay of the PCB according to the first signal delay and the second signal delay, and displays the signal group delay on a display device if the signal group delay does not satisfy a PCB design specification.

### BACKGROUND

1. Technical Field

Embodiments of the present disclosure relate to printed circuit board (PCB) analysis systems and methods, and particularly to a computing device, a storage medium, and a method for analyzing a signal group delay of data signal lines and clock signal lines included in a PCB.

2. Description of Related Art

Electronic apparatuses utilize high frequency clock signals in order to achieve high processing speeds and multifunctional abilities. In design of a printed circuit board (PCB) for an electronic apparatus, length of a clock signal line should be equal to length of a data signal line corresponding to the clock signal line. In order to evaluate a signal delay between the data signal line and the clock signal line, a designer conventionally performs a timing analysis to examine whether the signal delay satisfies PCB design specifications. If the signal delay fails to satisfy the PCB design specifications, the designer determines that the layout design of the data line and the clock signal line should be redesigned in the PCB.

However, it is difficult to make sure that the length of each clock signal line equals to the length the data signal line during the design of a PCB, and such design error may result in signal delay failing to satisfy the PCB design specifications. Therefore, there is need for a system and method for analyzing a signal group delay between the data signal lines and clock signal lines, to make sure that a layout of the PCB satisfies the PCB design specifications.

### BRIEF DESCRIPTION OF THE DRAWINGS

FIG. 1 is a block diagram of one embodiment of a computing device including a signal group delay analysis system.

FIG. 2 is a flowchart of one embodiment of a method for analyzing a signal group delay of a PCB using the computing device of FIG. 1.

FIG. 3 is a schematic diagram illustrating one example of a pair of data signal line and a pair of clock signal line included in a PCB.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

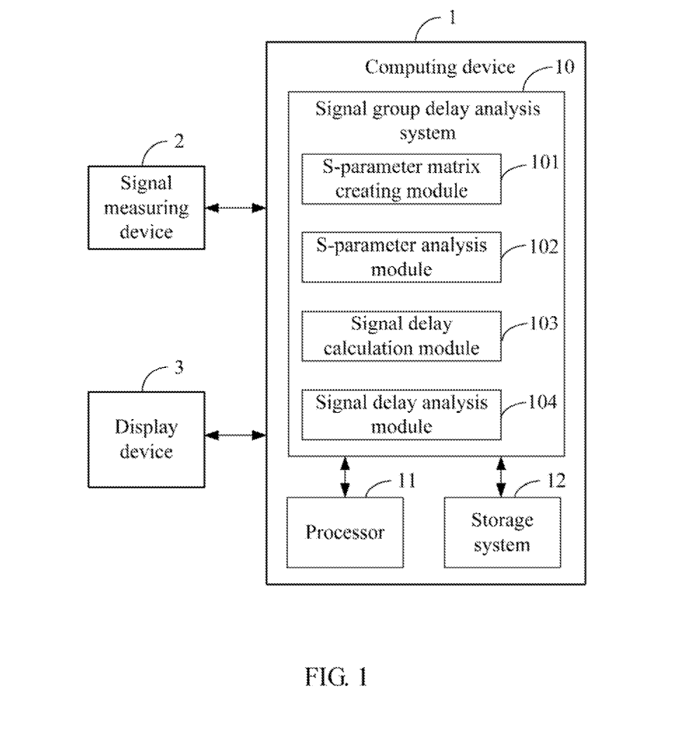

FIG. 1 is a block diagram of one embodiment of a computing device 1 including a signal group delay analysis system 10. In the embodiment, the computing device 1 electronically connects to a signal measuring device 2 and a display device 3. The computing device 1 may further include at least one processor 11 and a storage system 12. The signal group delay analysis system 10 may include a plurality of functional modules that are stored in the storage system 12 and executed by the at least one processor 11. It is understood that FIG. 1 is only one example of the computing device 1 that includes more or fewer components than those shown in the embodiment, or have a different configuration of the various components.

In one embodiment, the signal measuring device 2 may be an oscilloscope that is used to measure a plurality of S-parameters from a pair of data signal lines and clock signal lines of a printed circuit board (PCB). In one embodiment, the PCB may be a motherboard of a computer or a passive circuit board of an electronic apparatus, such as a game machine or a household appliance. The PCB may include a plurality of data signal lines (e.g., two data signal lines) and a plurality of clock signal lines (e.g., two clock signal lines). Each of the data signal lines is used to transmit data from one component (e.g., a memory) to another component (e.g., a CPU) installed in the PCB, and each of the clock signal lines is used to transmit a clock signal for controlling the data transmission on different components of the PCB. Each of the S-parameters is a signal parameter representing an electrical frequency of the signal, such as an incident voltage parameter and a reflective voltage parameter.

The signal group delay analysis system 10 analyzes a signal delay of each of the data signal lines and the clock signal lines included in the PCB, and verifies whether a length of the data signal line is equal to a length of the clock signal line. In one embodiment, the signal delay is defined as a time difference between a data transmission time of the data signal line and a clock transmission time of the clock signal line.

In one embodiment, the signal group delay analysis system 10 includes an S-parameter matrix creating module 101, an S-parameter analysis module 102, a signal delay calculation module 103, and a signal delay analysis module 104. The modules 101-104 may comprise computerized instructions in the form of one or more programs that are stored in the storage system 12 and executed by the at least one processor 11. A detailed description of each module will be given in the following paragraphs.

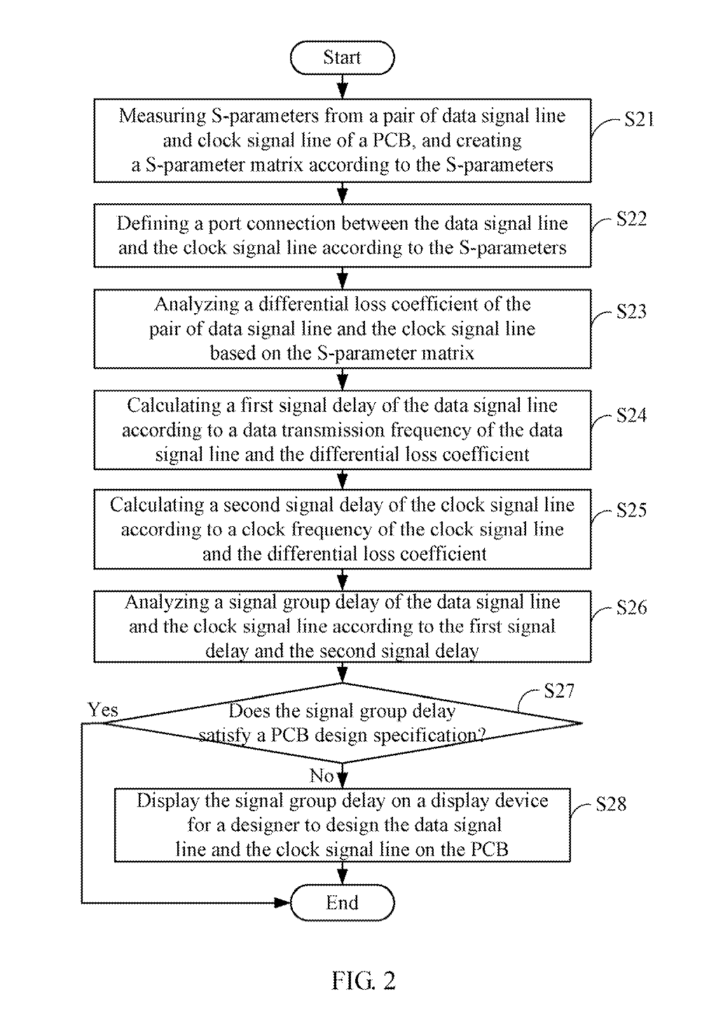

FIG. 2 is a flowchart of one embodiment of a method for analyzing a signal group delay of data signal lines and clock signal lines using the computing device 1 of FIG. 1. Depending on the embodiment, additional blocks may be added, others removed, and the ordering of the blocks may be changed.

In block S21, the S-parameter matrix creating module 101 obtains a plurality of S-parameters from a pair of data signal lines and clock signal lines measured by the signal measuring device 2, and creates a S-parameter matrix according to the S-parameters. In one embodiment, each of the S-parameters is a signal parameter representing an electrical frequency, such as an incident voltage parameter and a reflective voltage parameter. The S-parameter matrix is created using a circuit simulation tool, such as a SPICE program or a HSPICE program.

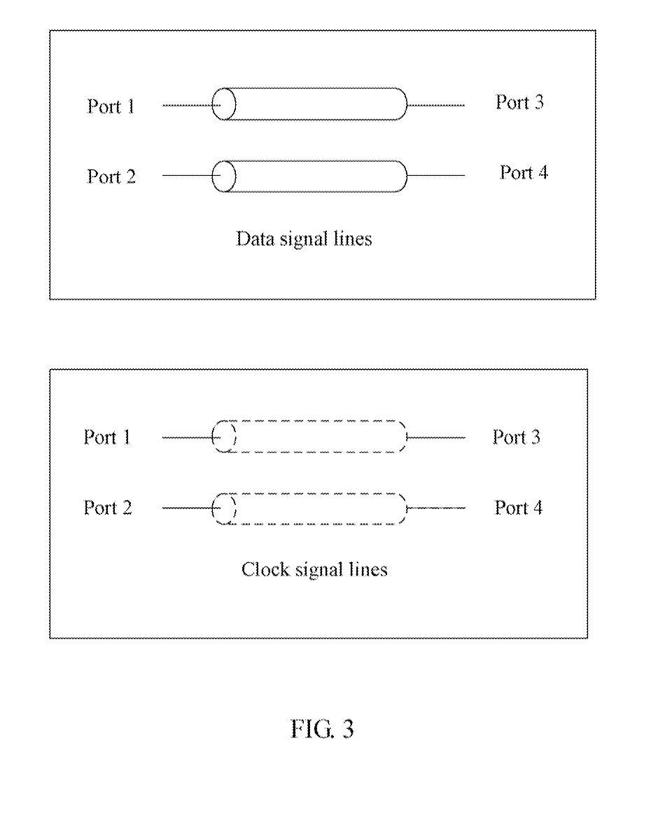

In block S22, the S-parameter analysis module 102 defines a port connection between each of the data signal lines and a clock signal line corresponding to the data signal line according to the S-parameters. In one embodiment, the S-parameter analysis module 102 may define the port connection as a standard timing connection if the S-parameters of the data signal line are identical to the S-parameters of the clock signal line. The standard timing connection is defined as a correct port relationship between a data signal line and a clock signal line corresponding to the data signal line. Referring to FIG. 3, the port 1 of the data signal line connects to the port 3 of the clock signal line, and the port 2 of the data signal line connects to the port 4 of the clock signal line.

In block S23, the S-parameter analysis module 102 analyzes a differential loss coefficient of the data signal line and the clock signal line based on the S-parameter matrix. In one embodiment, the differential loss coefficient is defined as a voltage input loss of the clock signal line when data is transmitted on the data signal line, and can be represented by the voltage loss “SDD11”, “SDD12”, “SDD21” and “SDD22” according to the S-parameter matrix. The S-parameter analysis module 102 defines the voltage loss “SDD21” as the differential loss coefficient of the data signal line and the clock signal line according to the port connection between the data signal line and the clock signal line.

In block S24, the signal delay calculation module 103 calculates a first signal delay of the data signal line according to a data transmission frequency of the data signal line and the differential loss coefficient. In one embodiment, the data transmission frequency of the data signal line may be denoted as “ω1”, and the differential loss coefficient is the voltage loss “SDD21” that is a complex number, which can be extracted as a phase value φ(ω1). The signal delay calculation module 103 calculates a first signal delay τ1(ω) of the data signal line using a first differential formula τ1(ω)=−τ1(ω)/δω1.

In block S25, the signal delay calculation module 103 calculates a second signal delay of the clock signal line according to a clock frequency of the clock signal line and the differential loss coefficient. In one embodiment, the data transmission frequency of the data signal line may be denoted as “ω2”, and the differential loss coefficient is the voltage loss “SDD21” that is a complex number, which can be extracted as a phrase value φ(ω2). The signal delay calculation module 103 calculates a second signal delay τ2(ω) of the clock signal line using a second differential formula τ2(ω)=−δτ2(ω)/δω21.

In block S26, the signal delay analysis module 104 analyzes a signal group delay of the data signal line and the clock signal line according to the first signal delay and the second signal delay. In one embodiment, the signal delay analysis module 104 calculates a time difference between the first signal delay and the second signal delay to obtain signal group delay of the data signal line and the clock signal line. The time difference is an absolute value of the first signal delay and the second signal delay, and is calculated according to the equation: TD=|τ1(ω)−τ2(ω)|.

In block S27, the signal delay analysis module 104 determines whether the signal group delay satisfies a PCB design specification. In one embodiment, the PCB design specification may define a timing restriction of the clock signal line included in the PCB, and the timing restriction is defined as 6 mil per second, for example. If the signal group delay does not satisfy the PCB design specification, block S28 is implemented. Otherwise, if the signal group delay satisfies the PCB design specification, the flow is ended.

In block S28, the signal delay analysis module 104 displays the signal group delay of the data signal line and the clock signal line on the display device 3 for showing a designer to design the data signal line and the clock signal line on the PCB. Thus, the designer can arrange the layout of the PCB according to the data signal line and the clock signal line.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing device connected to a signal measuring device and a display device, the computing device comprising:
a storage system;
at least one processor; and
one or more programs stored in the storage system and executable by the at least one processor, the one or more programs comprising:
an S-parameter matrix creating module that obtains a plurality of S-parameters from a pair of data signal lines and clock signal lines of a printed circuit board (PCB) measured by the signal measuring device, and creates an S-parameter matrix according to the S-parameters;
an S-parameter analysis module that defines a port connection between the data signal line and the clock signal line according to the S-parameters, and analyzes a differential loss coefficient of the pair of data signal line and clock signal line based on the S-parameter matrix;
a signal delay calculation module that calculates a first signal delay of the data signal line according to a data transmission frequency of the data signal line and the differential loss coefficient, and calculates a second signal delay of the clock signal line according to a clock frequency of the clock signal line and the differential loss coefficient; and
a signal delay analysis module that analyzes a signal group delay of the data signal line and the clock signal line according to the first signal delay and the second signal delay, determines whether the signal group delay satisfies a PCB design specification, and displays the signal group delay on the display device if the signal group delay does not satisfy the PCB design specification.

2. The computing device according to claim 1, wherein the S-parameter analysis module defines the port connection as a standard timing connection if the S-parameters of the data signal line are identical to the S-parameters of the clock signal line.

3. The computing device according to claim 1, wherein the differential loss coefficient is defined as a voltage input loss of a clock signal line when data is transmitted on a data signal line corresponding to the clock signal line, and is a complex number that consists of a phase value of the data signal line and a phase value of the clock signal line.

4. The computing device according to claim 1, wherein the signal delay analysis module obtains the signal group delay of the data signal line and the clock signal line by calculating a time difference between the first signal delay and the second signal delay, and the time difference is an absolute value of the first signal delay and the second signal delay.

5. The computing device according to claim 1, wherein each of the S-parameters is a signal parameter representing an electrical frequency that is an incident voltage parameter or a reflective voltage parameter.

6. The computing device according to claim 1, wherein the S-parameter matrix is created using a circuit simulation tool that is a SPICE program or a HSPICE program.

7. A method for analyzing a signal group delay of a printed circuit board (PCB) using a computing device, the computing device connected to a signal measuring device and a display device, the method comprising:
obtaining a plurality of S-parameters from a pair of data signal line and clock signal line of the PCB measured by the signal measuring device, and creating an S-parameter matrix according to the S-parameters;
defining a port connection between the data signal line and the clock signal line according to the S-parameters;
analyzing a differential loss coefficient of the pair of data signal line and clock signal line based on the S-parameter matrix;
calculating a first signal delay of the data signal line according to a data transmission frequency of the data signal line and the differential loss coefficient;
calculating a second signal delay of the clock signal line according to a clock frequency of the clock signal line and the differential loss coefficient;
analyzing a signal group delay of the data signal line and the clock signal line according to the first signal delay and the second signal delay;
determining whether the signal group delay satisfies a PCB design specification; and
displaying the signal group delay on the display device if the signal group delay does not satisfy the PCB design specification.

8. The method according to claim 7, wherein the port connection is defined as a standard timing connection if the S-parameters of the data signal line are identical to the S-parameters of the clock signal line.

9. The method according to claim 7, wherein the differential loss coefficient is defined as a voltage input loss of a clock signal line when data is transmitted on a data signal line corresponding to the clock signal line, and is a complex number that consists of a phase value of the data signal line and a phase value of the clock signal line.

10. The method according to claim 7, wherein the signal group delay of the data signal line and the clock signal line is obtained by calculating a time difference between the first signal delay and the second signal delay, and the time difference is an absolute value of the first signal delay and the second signal delay.

11. The method according to claim 7, wherein each of the S-parameters is a signal parameter representing an electrical frequency that is an incident voltage parameter or a reflective voltage parameter.

12. The method according to claim 7, wherein the S-parameter matrix is created using a circuit simulation tool that is a SPICE program or a HSPICE program.

13. A non-transitory computer-readable medium having stored thereon instructions that, when executed by at least one processor of a computing device, causes the computer to perform a method for analyzing a signal group delay of a printed circuit board (PCB), the computing device connected to a signal measuring device and a display device, the method comprising:
obtaining a plurality of S-parameters from a pair of data signal line and clock signal line of the PCB measured by the signal measuring device, and creating an S-parameter matrix according to the S-parameters;
defining a port connection between the data signal line and the clock signal line according to the S-parameters;
analyzing a differential loss coefficient of the pair of data signal line and clock signal line based on the S-parameter matrix;
calculating a first signal delay of the data signal line according to a data transmission frequency of the data signal line and the differential loss coefficient;
calculating a second signal delay of the clock signal line according to a clock frequency of the clock signal line and the differential loss coefficient;
analyzing a signal group delay of the data signal line and the clock signal line according to the first signal delay and the second signal delay;
determining whether the signal group delay satisfies a PCB design specification; and
displaying the signal group delay on the display device if the signal group delay does not satisfy the PCB design specification.

14. The medium according to claim 13, wherein the port connection is defined as a standard timing connection if the S-parameters of the data signal line are identical to the S-parameters of the clock signal line.

15. The medium according to claim 13, wherein the differential loss coefficient is defined as a voltage input loss of a clock signal line when data is transmitted on a data signal line corresponding to the clock signal line, and is a complex number that consists of a phase value of the data signal line and a phase value of the clock signal line.

16. The medium according to claim 13, wherein the signal group delay of the data signal line and the clock signal line is obtained by calculating a time difference between the first signal delay and the second signal delay, and the time difference is an absolute value of the first signal delay and the second signal delay.

17. The medium according to claim 13, wherein each of the S-parameters is a signal parameter representing an electrical frequency that is an incident voltage parameter or a reflective voltage parameter.

18. The medium according to claim 13, wherein the S-parameter matrix is created using a circuit simulation tool that is a SPICE program or a HSPICE program.
